(19) United States
(12) Patent Application Publication
(10) Pub. No.: US 2010/0094694 A1
(43) Pub. Date: Apr. 15, 2010

(54) Rewards Program For Real Estate Sales and Other Uses

(76) Inventor: Craig Shapiro, Creve Coeur, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/572,063

(22) Filed: Oct. 1, 2009

Related U.S. Application Data
(63) Continuation-in-part of application No. 12/479,497, filed on Jun. 5, 2009.
(60) Provisional application No. 61/058,980, filed on Jun. 5, 2008.

(51) Int. Cl. G06Q 30/00; G06Q 40/00; G06Q 50/00

(52) U.S. Cl. 705/14.15

(57) ABSTRACT

A consumer-to-consumer rewards program that consumers can utilize to incentivize consumer sale or lease of goods to other consumers, such as real estate. Also disclosed herein is a universal rewards card in which a consumer can earn and spend points at any preferred retailer.

### CROSS REFERENCE TO RELATED APPLICATION(S)

This application is a Continuation-in-Part (CIP) of U.S. patent application Ser. No. 12/479,497 filed Jun. 5, 2009, which in turn claims benefit of U.S. Provisional Patent Application Ser. No. 61/058,980, filed Jun. 5, 2008. The entire disclosure of both documents is herein incorporated by reference.

### BACKGROUND

1. Field of the Invention

This invention relates to the field of rewards systems for the purchase of products from certain vendors. In particular, the present invention generally relates to a rewards system for distinguishing real estate and mortgages or similar secured loans, as well as a universal general rewards system useable on a variety of products.

2. Description of the Related Art

Loyalty marketing programs are an approach to business marketing, based on strategic management principles, in which a certain company focuses on retaining their existing customer base and attracting new customers through the use of incentive programs. At its core, loyalty marketing is an additional factor in the customer proposition; i.e., the subjective assessment performed by each given consumer of whether or not to purchase a brand based on the integrated combination of the value they receive from the incentive program. In other words, it is an additional way to distinguish a brand or product from the competition, outside of the characteristics of the brand or product that is being marketed.

To the general public, airline miles programs, hotel frequent guest programs and credit card incentive programs are the most commonly recognized loyalty marketing programs. Generally, these programs are associated with “loyalty cards,” which are, in and of themselves, tools of a loyalty marketing system. These cards, often called “loyalty,” “rewards” or “club” cards are generally plastic or paper cards, similar to credit cards, that identify the card holder as a member in a given loyalty program.

Loyalty Programs—A Historical Overview

The general concept of loyalty marketing, albeit in a remedial form, began in the 1930s with S &H Green Stamps®. In this program, as a customer shopped at various grocery and dry goods stores, they would receive a set number of Green Stamps that could be collected, pasted into booklets, and redeemed or exchanged for prizes. Thus, a customer collecting stamps for a certain prize or good was incentivized to shop only at retail locations that issued stamps; the program encouraged the consumer to return to the same stores.

Another early loyalty marketing program, besides the S & H Green Stamp® program was the marketing program creating by the baking brand Betty Crocker®. In 1929, Betty Crocker® issued coupons on its baked goods and grocery store products that could be collected and used to redeem items like free flatware. With time, Betty Crocker® began to improve upon its program, printing the coupons on the outside of its packaging and producing a popular reward catalog from which customers could choose from a large variety of varying rewards using their points.

The first full-scale loyalty marketing program of the modern era was launched by American Airlines in the early 1980s. Branded the AAdvantage Miles Program®, this program, revolutionary for its time, was the first to reward “frequent fliers” of American Airlines with reward miles that could be accumulated and later redeemed for free travel on American Airlines. Recognizing the incredible business value in providing customers with an incentive to exclusively use a company, regardless of individual ticket price, and be rewarded for their loyalty, many other airlines and travel providers began to launch similar programs.

Since the advent of the AAdvantage Miles Program®, rewards programs have become a matter of course in the airline and travel industry, and the concept of implementing a rewards program to encourage customer loyalty and entice new customers has been applied in several other industries and commercial settings.

For example, several major supermarket chains and at least one pharmacy chain have employed loyalty marketing programs. In these programs, a customer signs up for the retail chain's rewards program and is issued a loyalty card. The customer can then utilize the loyalty card as a form of identification when conducting transactions with that retailer. By presenting the card, the purchaser is typically entitled to either a discount on the current purchase, or an allotment of points that can be redeemed for a discount on future purchases. Moreover, some retailers also have tie-ins with airline frequent flyer programs and some even agree to offer a percentage of sales to a designated charity.

Loyalty marketing programs have also become common in entertainment retail industry, from large chains to independent stores. Common aspects of these programs are: programs that offer points redeemable for dollar-amount discounts after accumulating a set number of points; customer purchase of a card to receive a percentage discount on all purchases for a certain period of time; and programs that offer a customer a one-time percentage discount based upon reaching a specified purchase level.

Perhaps the most widely recognized modern loyalty marketing programs are those implemented by credit card companies. Rewards programs in the credit card industry developed as a result of intense competition between different credit card providers who were offering the same or similar services. In order to get a “step up” on competitors, and to attract customers to their card over the cards of their competitors, credit card companies began to offer incentives such as frequent flyer points, gift certificates, credit towards merchandise, or cash simply for using the credit card as a method of payment (typically up to 1% based on total purchases).

An important concept common to generally all modern rewards programs, whether in the retail, airline, credit card, or in another industry, is that the points accumulated by the consumer are utilized by the issuing entity to promote loyalty to the issuing entity's stores and/or products. For example, while American Express Rewards Points® may be redeemed at Ticketmaster® for a portion of the ticket purchase price, the program induces consumer loyalty to American Express (i.e., to charge more purchases to American Express so that the customer can earn more points and save more money on tickets) rather than inducing consumer loyalty to the incentivized Ticketmaster® product. Further, it is noted that the points accumulated by the customer in a particular loyalty program are only good at companies participating in that card's particular rewards program; e.g., you can redeem American Express Rewards Points® for tickets on Continental Airlines, but not on American Airlines. By not allowing the combination of points between programs; e.g., the commingling of American Express points and Visa points, companies ensure that these programs only generate consumer loyalty to their own brand, services and/or products.

Each of the aforementioned currently utilized rewards programs is a system in which the rewards program is used as a loyalty device for the given retailer, credit card company, airline, etc. There are several disadvantages to these types of programs. First, none of these programs are a consumer based program. Specifically, the framework of current rewards programs utilizes a business to business or business to consumer framework, but none of these rewards programs utilize a consumer to consumer framework. Accordingly, the current rewards programs can not be used by a consumer to distinguish high priced goods which the consumer wishes to sell. The most prominent example of a high priced consumer-sold good for which such a rewards program would be beneficial would be real estate.

Second, generally the rewards points offered in each of the currently utilized rewards programs are points exclusive to a particular rewards program, intended to promote loyalty to the particular retailer, credit card, etc. with whom the program is associated. None of these programs offers universal rewards points or the ability to combine points accumulated in one program with points accumulated in another program. For example, a consumer cannot combine points accumulated on their American Express card with points accumulated on their Borders' Rewards Card®. This isolated nature of currently utilized loyalty programs leads to the unpleasant consequence of a bevy of card for a single individual to carry around, use and remember: a Dillard's card, a Best Buy card, a CVS card, a Kroger's card, etc. This multiplicity of cards can become an unpleasant weight and burden for a given consumer.

Third, since current rewards programs are exclusive to specific retailers, that individual retailer becomes responsible for the added administrative costs and labor inherent in running the rewards program. This task can be particularly daunting for small to medium sized businesses.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are, among other things, a rewards program for consumer-to-consumer transactions of consumer bought and sold goods, comprising: a consumer-seller; a consumer-buyer; and a third party entity offering rewards points; wherein the consumer-seller decides to sell a consumer good; wherein the consumer-seller decides to purchase a certain amount of rewards points from the third party entity offering rewards points to incentivize the purchase of the consumer good; wherein the consumer-seller uses the rewards points to purchase additional goods or services to offer to the consumer-buyer; and wherein the consumer-buyer is incentivized to purchase the consumer good based on the additional goods or services purchased with the rewards points.

In an embodiment of the rewards program the consumer bought and sold goods is real estate.

In an embodiment of the rewards program the consumer bought and sold goods is a mortgage.

In an embodiment, the rewards program further comprises a buyers' real estate agent, wherein the consumer-seller gives the reward points to the buyers' real estate agent to encourage showing the consumer-seller's real estate.

In an embodiment of the rewards program the amount of rewards points purchased represents one percent of the purchase price of the consumer good.

In an embodiment, the purchase of the rewards points is performed by a computer and may occur when the purchase of the consumer good is completed.

There is also described herein a rewards program for consumer-to-consumer transactions of consumer leased goods, comprising: a consumer-seller; a consumer-buyer; and a third party entity offering rewards points; wherein the consumer-seller decides to lease a consumer good; wherein the consumer-seller decides to purchase a certain amount of rewards points from the third party entity offering rewards points to incentivize the lease of the consumer good; wherein the consumer-seller uses the rewards points to purchase additional goods or services to offer to the consumer-buyer; and wherein the consumer-buyer is incentivized to enter the lease based on the additional goods or services purchased with the rewards points.

In an embodiment, the leased goods is real estate.

In an embodiment, the amount of rewards points purchased represents one percent of the total value of the lease.

In an embodiment, the purchase of the rewards points is performed by a computer and may occur when the lease is executed.

There is also described herein a method for distinguishing real estate sales with rewards points comprising: purchasing a certain amount of rewards points from a third party entity; using the rewards points to buy incentives that will distinguish a home on the market; offering the rewards points to buyers' real estate agents to incentivize showing the home on the market to potential consumer-buyers; and selling the home on the market to a potential consumer-buyer due to the consumer-seller's use of the rewards points to distinguish their property.

There is also described herein a universal rewards card for increasing merchant loyalty, comprising a first step of an entity associating its business with the universal rewards program to become a preferred vendor; a second step of a consumer obtaining universal rewards points from purchases at the preferred vendor; a third step of a consumer using the obtained universal rewards points for purchases at any vendor; and wherein the universal rewards card is a loyalty device for the participating consumers.

### BRIEF DESCRIPTION OF THE DRAWINGS

FIG. 1 provides a diagram of an embodiment of the rewards system for real estate transactions.

FIG. 2 provides a diagram of an embodiment of the rewards system in conjunction with a real estate lease.

FIG. 3 provides a diagram of an embodiment of the universal rewards card.

### DESCRIPTION OF THE PREFERRED EMBODIMENT(S)

The following detailed description illustrates by way of example and not by way of limitation. Described herein, among other things, is a rewards program, which utilizes a consumer to consumer framework, for use in the home sale or lease market as a tool for distinguishing real estate and mortgages or similar secured documents. Also described herein is a universal rewards system in which points earned are not restricted to one particular merchant, but are universal and can be redeemed at any preferred vendor.

Rewards System for Real Estate Transactions

Prior to the describing the particular elements and embodiments of this aspect of the present disclosure, it is important to note that the consumer to consumer rewards program described herein can be utilized with any consumer-sold good known to those of skill in the art (e.g., high priced art sales, used auto sales, boat sales, etc.). For exemplary purposes, the consumer-to-consumer rewards framework disclosed herein will be described in the context of real estate transactions. However, the reader should not lose sight of the fact that this rewards process and methodology can be applied to any consumer-to-consumer sales transaction known to those of skill in the art.

It should be recognized that the present transaction can take place in a variety of fashions. in one embodiment, the transaction will occur as a part of an electronic sales transaction. In this embodiment, a computer system may be used to obtain the reward points via an automated transaction. The computer system can also provide for automation in redeeming or transferring the reward points from a consumer-seller to a consumer-buyer.

In an embodiment of the rewards system for real estate transactions, the rewards system generally comprises three main steps: the consumer-seller purchases rewards points for the promotion of consumer goods; the rewards points can be redeemed for commercially reasonable consumer incentives; and the consumer-seller utilizing the rewards points to distinguish their products and incentivize a purchasing consumer to purchase their goods. These steps will each be discussed individually, and then as components of the disclosed rewards system as a whole. In an embodiment, the system may be automated to allow for the purchase and sale of the reward points to take place automatically. For example, when the property is listed for sale in a computer system, the computer system may automatically determine the amount of reward points to be offered and then can indicate the rewards that can be obtained with those points. This can be part of the initial listing of a property to allow for immediate recognition of the availability of reward points.

Generally, in the first step of the rewards system for real estate transactions, the consumer-seller of the home, or other real estate (e.g., a condominium, a piece of real property, a time-share, etc.) pays a percentage of the listed sales price of the home to receive a certain fixed amount of points. For example, in one embodiment of the rewards system for real estate transactions, the consumer-seller pays one percent (1%) of the listed sales price of the home and receives one hundred (100) points for every dollar paid. Thus, if the consumer-seller's home is listed for two hundred and fifty thousand dollars ($250,000), in order to obtain two hundred fifty thousand points (250,000), the seller would have to pay two thousand five hundred dollars ($2,500) of the purchase price ($2,500×100 points=250,000 points). In the grand schematic of the high-priced and competitive home sale market, the sum of money spent by the consumer-seller to obtain X number of rewards points will be nominal in comparison to the benefit the points give to the consumer-seller in distinguishing his or her home to potential consumer-buyers and securing a purchase.

In one embodiment of this first step, the consumer-buyer will purchase his or her rewards points from their real estate agent. However, it should be noted that it is contemplated that the consumer-seller can purchase his or her rewards points from any entity or third party that offers points to consumer-sellers to incentivize consumer-to-consumer purchasing.

It is contemplated in this disclosure that the rewards points purchased by the consumer-seller have a generally universal application, i.e., that they can be used to “purchase” a variety of different goods, merchandise, and services. For example, in one embodiment of the rewards program the rewards points can be redeemed for merchandise, travel expenses (hotel, airfare, tours, cruises, etc.), concert/show tickets, and home needs (landscaping services, home improvements services, community organization fees, country club fees, etc.). Generally, any reward redeemable for a point known to those of skill in the art now or in the future is contemplated in this application.

In another embodiment, it is contemplated that the points purchased by the consumer-seller can be used specifically for products or services directly related to the sale of the home. For example, points could be used to provide a refrigerator for the home, or to pay for the trust company, appraisal, surveyor and/or inspector fee(s) commonly associated with real estate sales. In yet another embodiment, the points received could be redeemable for home warranties, auto insurance, home insurance or any other type of similar warranty or insurance instrument commonly associated with home ownership and/or home sales.

Generally, after purchasing the points, the consumer-seller will use the rewards points purchased as an incentive to potential customer-buyers or customer-buyer's real estate agents. Thus, the points the customer-seller obtains will act as an incentive to buyers who are looking to purchase the consumer-seller's property. Alternatively, the points will act as an incentive to the buyers' real estate agents to show the consumer-seller's property. For example, a buyers' real estate agent will be more likely to show and put a good “spin” on the consumer-seller's property knowing that they will receive X number of points for each potential consumer-buyer to whom they show the consumer-seller's property.

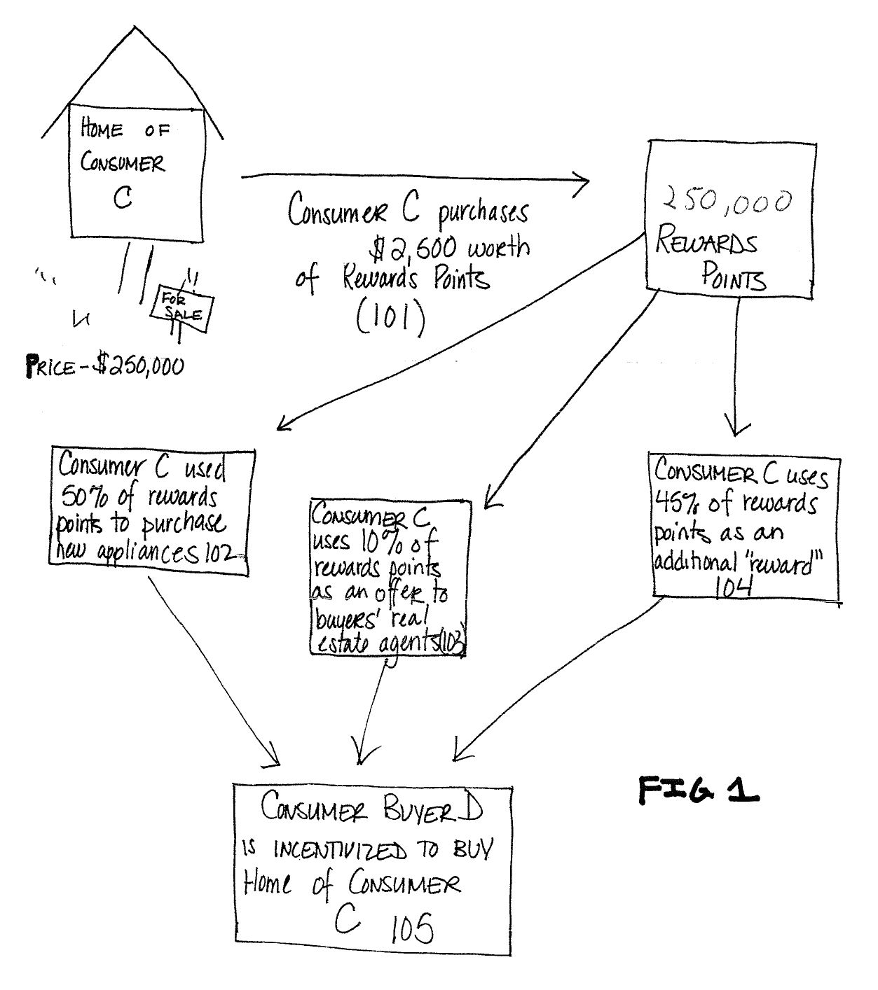

Thus, in sum, the disclosed rewards system for real estate transactions will generally work as follows as depicted in FIG. 1. Consumer-seller C, having received a raise and expecting another addition to the family, decides to sell his current home and move into a larger and more substantial property. His current home is worth approximately two hundred and fifty thousand dollars ($250,000), and the new home he is looking to purchase is worth approximately seven hundred and fifty thousand dollars ($750,000). Currently the housing market favors the buyer, and consumer-seller C also has to deal with the fact that four other families who own houses similar in size, construction and age in his neighborhood to the home he is trying to sell are on the market at the same time. Moreover, consumer-seller C has a time-crunch consideration; he must sell his old property within six (6) months, or he will have to pay for two mortgages (the mortgage on his current, soon to be old, home and the mortgage on his new property). Consumer-seller C needs a way outside to distinguish his home in the market.

Accordingly, in a first step (101) consumer-seller C decides to purchase two thousand five hundred dollars worth of rewards points from his real estate agent, and use them to create a more attractive package for the sale of his home. In the long run equation of mortgage financing, this two thousand five hundred dollars will seem nominal when juxtaposed with the benefit of distinguishing his property from the market such that it sells quicker and, potentially, he receives a better price. One obtained, in a second step (102), consumer-seller C uses fifty percent (50%) the rewards points to purchase new appliances for the kitchen and a new state-of-the-art surround sound home theater audio system for the home's family room. These additions to the home the consume-seller is marketing an aura of class and modernity that was missing from the old set-up, attracting consumer-buyers to purchase the home. Further, in a third step (103) the consumer-seller uses ten percent (10%) of the rewards points purchased and offers them to buyers' real estate agents who show, discuss and encourage purchase of the home with their respective consumer-buyers. This increases consumer-buyer traffic to the home, thereby increasing competition and the potential consumer-buyer purchase pool. In a fourth step (104), the consumer-seller uses the remaining forty-five percent (45%) of the purchased points as an additional “reward” for purchasing the home. These points can be presented to potential consumer-buyers as redeemable for all closing costs (title insurance fees, appraisal fees, surveyor fees, etc.), home insurance, yearly fees to the local country club, or simply for entertainment (concert tickets, movies, etc.) or other incentivizing consumer purchases. In a fifth step (105), potential consumer-buyer D will be more likely to buy consumer-seller C's home in this situation, then the other homes in the neighborhood on sale at the same time due to these incentives that were the direct result of the consumer-seller C's purchase of the rewards points.

In another embodiment of the rewards system for real estate transaction disclosed herein, the consumer-to-consumer framework that is at the base of the real estate rewards system is utilized by mortgage brokers, banks, financiers, or other entities in the mortgage industry to incentivize potential consumers; i.e., individuals looking to take out a mortgage to assist in financing the purchase of their first home—to obtain a mortgage through their company. Similar to the aforementioned embodiment where the points are utilized by a consumer to incentivize the purchase of their home on the real estate market, the points in this embodiment would be based on the price of the home and, thereby, the amount of the mortgage or similarly secured loan. In other words, in an embodiment, a person obtaining a loan would receive 100 points for every dollar of the mortgage or similarly secured loan. This could make a particular mortgage company more attractive to a given consumer than another mortgage company; especially when the mortgages companies are each offering mortgages with similar terms and interest rates.

Taken together, the following are some advantages of the disclosed consumer-to-consumer rewards program wherein the rewards are used for distinguishing real estate, mortgages or similarly secured loans. One, due to the incentives, a consumer-seller will be able to sell a piece of property at a faster rate than they normally would in the market. Two, due to the incentive, a consumer-seller will be able to sell a home closer to the list price. Three, the incentives will bring attention to the property since the concept is so unique to the real estate marketplace. Four, the incentives could assist in bringing in new listings. Five, the incentives could be used to promote more showings of the seller's home (i.e., when given to buyer's agents). Six, the incentives could be used to differentiate the seller's property from the thousands of other properties on the market.

As contemplated above, the system can be completely automated in its application. For example a real estate agent can sign up to have all their listings provided with reward points on behalf of its clients. When the real estate agent provides a computer entry of the property being for sale, the computer may automatically calculate the number of reward points that will go with the house, and will then provide indications of the products or services that the potential purchaser may obtain with the property. Thus, a smaller property may provide that the consumer-purchaser can get a trip to Las Vegas or a new TV, while a larger property may provide a trip to Europe or a complete set of new appliances. This automation can be based by having computer software which can determine an amount of points to be provided based on a predetermined formula and can then look up from a website or computer redemption center what that amount of points can be spent on. In order to provide a good incentive, the types of goods and services may be chosen from specific categories. Further, in this situation, the reward points need not be actually purchased until the sale of the underlying property is completed. In this way, should the property fail to sell, the consumer-seller has not invested the money in obtaining the reward points.

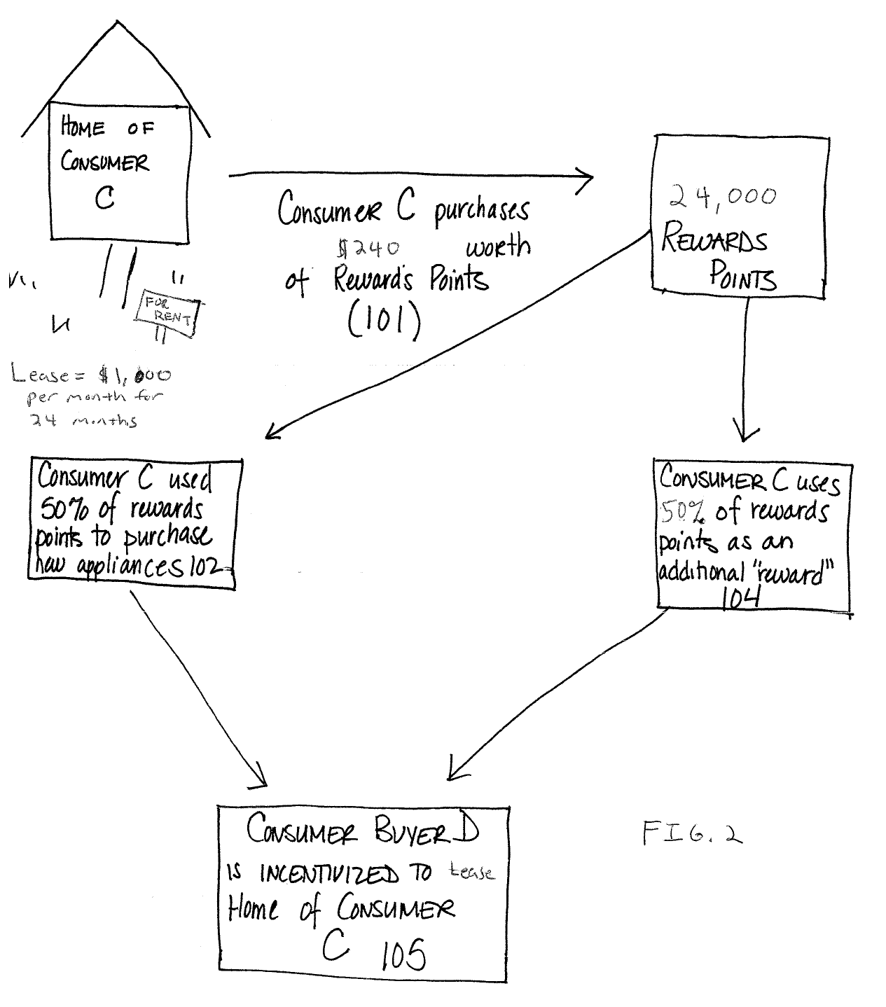

FIG. 2 provides for an alternative embodiment of the rewards system as it can be used in conjunction with real estate and other large ticket items. While these items are bought and sold, particularly with regards to real estate, it is also common to have leasing or rental transactions. As in the purchasing case, the leasing of big ticket items can also be incentivized using the reward system of the present discussion.

In a leasing situation, the reward system will operate in a generally similar fashion to what was used in the purchase situation, however, in the leasing situation the reward will go along with a lease of the property instead of a sale. Specifically, the renter or leaser will obtain the rewards in order to differentiate the lease over an alternative lease. In the purchase situation, the amount of reward points was generally based on spending 1% of the value of the property asking price which provides reward points equal to the asking price of the property. In the lease situation, there is no fixed property value. Thus, in selecting the amount of the reward, the leaser may use any initial starting point value as the value of the reward points.

In an embodiment, this may be based on the total value of the lease over its entire length. For example, if the lease is $1,000 a month for 24 months, the value may be selected of $24,000 and thus 24,000 reward points are purchased. Alternatively, any other value may be selected. For example, the leaser could obtain the points based on the underlying value of the rental property. As in the purchase situation, the reward points may then be used to provide for incentives to contract for this lease as opposed to a different lease. The reward points may be used to provide, for example, a vacation with the signing of the lease. Alternatively, they may be used to provide the lessee with an upgraded TV or appliances which may remain with the property or can be taken with the renter when they exit the lease.

Regardless of the rewards provided, the incentive in the lease situation will generally be the same as discussed above for the purchase situation. Similarly with a lease as with a purchase, the increased cost imposed to the leaser to obtain the points is generally small compared to the lease payment. The cost may be incorporated into the lease payment or can simply be absorbed by the leaser as part of the expense of finding a renter. In the lease situation, the reward points can also be used to obtain longer term or “upsold” leases as well. For example, the leaser could offer the reward points only on larger rental units or only with longer term leases.

As in the purchase situation, the points can also be used to incentivize a party other than the direct contracting party (lessee). For example, the reward points can be provided as a benefit for providing a referral which led to the lease being completed. Similarly, the reward points could be used as an incentive to a listing agent for the lease to provide them with incentive to push the listed property over others. The reward points could also be used to provide for an incentive for an existing lessee to remain in the property. For example, they may not be provided with a new lease, but could be provided if a lease was renewed or could be provided to the lessee in lieu of the leaser performing certain improvements. For example, the leaser could provide points suitable for purchasing a new dishwasher instead of providing an updated dishwasher or painting the property this year. The lessee could then decide if they preferred to obtain the upgraded dishwasher, or could continue to use the old one and take a vacation instead, for example. The above represent merely a representative sampling of possible uses of the reward points and other uses would be understood by one of ordinary skill

As should be clear form then above, the use of reward points to incentive the purchase or rental of big ticket items can provide for an additional way to differentiate items when relative prices for comparable items may be considered less important. This is particularly true for real property as this is often the largest item that an individual will own. At the same time, the incentives can be provided on any large ticket item and may be used, for example, on yachts, private jets, or similar items which are being sold consumer to consumer. In this case, the sale of such items would generally be for “pre-owned” or “used” items which items were purchased by the consumer-seller for their use. However, the consumer-seller no longer has need of them and is now selling them on a secondary market to the consumer-buyer. The incentive rewards thus allow for the seller on the secondary market to differentiate their goods in a fashion other than price.

As in the sale situation, in the lease situation the process can again be automated to provide that the points are automatically purchased and the reward indications are automatically provided. This could be particularly desirable for a consumer-seller that owns a number of rental properties and therefore may have a number of available properties at any time.

Universal Rewards Card

Also described in the present disclosure is a universal rewards card; the rewards points associated with said rewards card being accumulated from a plurality of vendors, companies and merchants and capable for use on a universal scale at a plurality of vendors and merchants; wherein the universal rewards card is a loyalty device for the participating merchants.

It is contemplated that the universal rewards card, as discussed herein, will have no limitation on the use of the points accumulated on the card via the rewards program. Thus, it is contemplated that the universal rewards card may be accepted everywhere, whether an individual pays by credit card, check or cash. Accordingly, the points of the universal rewards card program are used as a loyalty device for each merchant involved in the program, not the rewards program itself. Instead of encouraging loyalty to the specific brand/merchant to whom the rewards program is tied, as the rewards programs currently utilized in the art, the universal applicability and utility of the rewards associated with this card encourage consumers to spend money not just at a single merchant, but rather at any preferred merchant associated with the card. In other words, the points accumulated by a consumer can be accumulated, combined and used at a number of participating merchants.

As a initial step of the universal rewards program described herein, a given company decides to associate its business with the universal rewards program. In one embodiment, it is contemplated that national companies will be enticed to associate with the universal rewards program by soliciting their participation with time sensitive exclusive engagement periods, e.g., a six (6) month or year membership. During that time period, the newly enrolled company will be able to promote a new consumer base via the loyalty marketing advantage obtained through the universal rewards card; i.e., the national company will have an exclusive period of time over their competitors to establish a loyalty with consumers involved in the rewards program. This exclusive engagement period will entice companies to sign onto the universal rewards program faster than would be expected and “waiting to see what happens.”

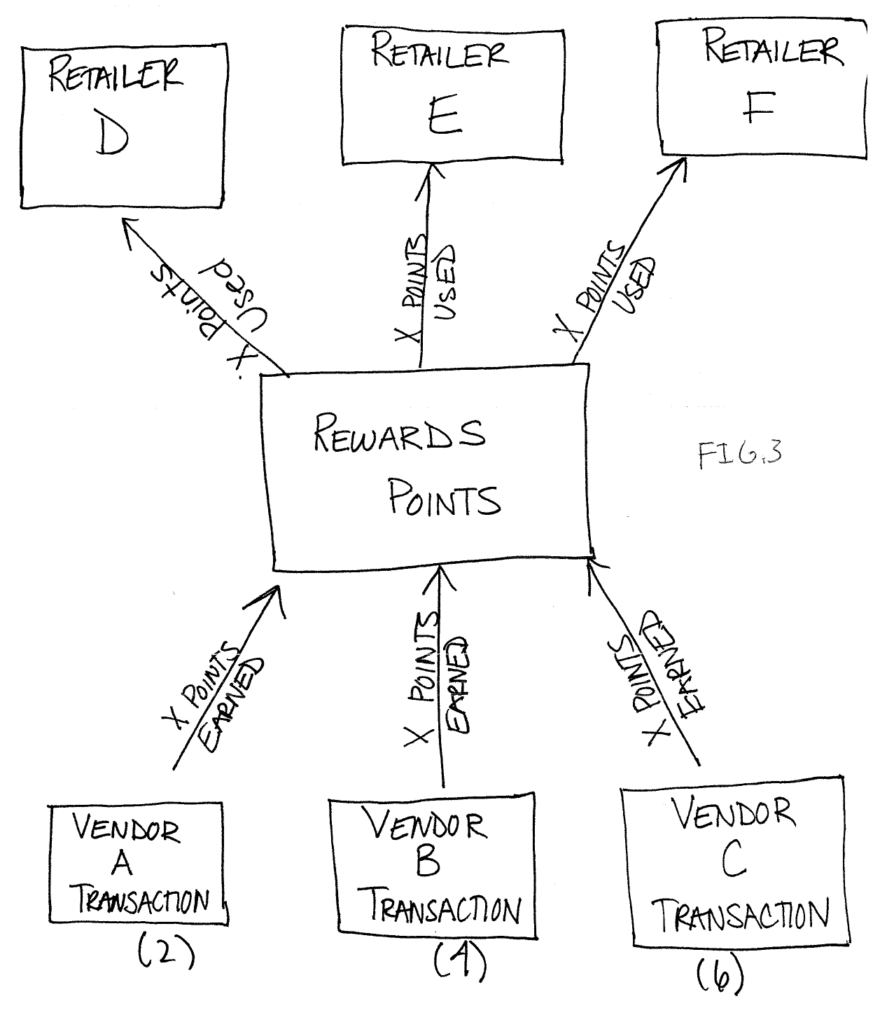

In one embodiment of the universal rewards card, as shown in FIG. 3, consumer A makes three purchases. Consumer A's first purchase of groceries is from Vendor A and consumer A earns X amount of universal rewards points (2). Consumer A's second purchase of clothes is from Vendor B and consumer A earns X amount of universal rewards points (4). Consumer A's third purchase of home appliances is from Vendor C and consumer A earns X amount of universal rewards points (6). Then Consumer A makes three purchases with universal rewards points: one purchase from Vendor D using X amount of points, one purchase from Vendor E using X amount of points, and one purchase from Vendor F using X amount of points. Thus, as seen in FIG. 2, the way in which consumers can earn and use points in the universal rewards program disclosed herein is more flexible and liquid than current rewards program structures.

In the disclosed embodiment of the universal rewards program, consumer loyalty is geared toward individual merchants involved in the program, rather than the rewards card or the rewards program in and of itself. This feature of the universal rewards card remains over time due to the fact that the rewards card can be used as a tool by a number of different individual merchants as a general promotional tool to establish loyalty.

Further, in the disclosed embodiment of the universal rewards program, utilization of the universal rewards card by smaller and local merchants will give them a competitive edge against larger businesses. Historically, these smaller merchants do not have the sales volume to warrant giving points when a consumer might only shop, eat, spend money there once a month . . . perhaps only a few times a year. With the universal rewards program disclosed herein however, these merchants will be able to compete by offering incentives to potential and current consumers via enlisting with the rewards program as a preferred vendor.

Another aspect of the disclosed embodiment of the universal rewards program is the ability it affords to consolidate current rewards programs utilized in the art. For example, a consumer of the universal rewards card can earn points and redeem points at any preferred retailer. Thus, they bevy of different rewards cards carried around by an individual consumer is no longer needed—all a consumer will need is the universal rewards card. This increases the ease of use for the consumer, along with decreasing the number of rewards cards the consumer needs to carry around.

Another aspect of the disclosed embodiment of the universal rewards card program is the elimination of administrative fees traditionally associated with running rewards programs that are imposed on individual vendors and merchants utilizing traditional rewards program and card modalities.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A rewards program for consumer-to-consumer transactions of consumer bought and sold goods, comprising:
a consumer-seller;
a consumer-buyer; and
a third party entity offering rewards points;
wherein said consumer-seller decides to sell a consumer good;
wherein said consumer-seller decides to purchase a certain amount of rewards points from said third party entity offering rewards points to incentivize the purchase of said consumer good;
wherein said consumer-seller uses said rewards points to purchase additional goods or services to offer to said consumer-buyer; and
wherein said consumer-buyer is incentivized to purchase said consumer good based on said additional goods or services purchased with said rewards points.

2. The rewards program for consumer-to-consumer transactions of claim 1, wherein said consumer bought and sold goods is real estate.

3. The rewards program for consumer-to-consumer transactions of claim 1, wherein said consumer bought and sold goods is a mortgage.

4. The rewards program for consumer-to-consumer transactions of claim 2 further comprising a buyers' real estate agent, wherein said consumer-seller gives said reward points to said buyers' real estate agent to encourage showing said consumer-seller's real estate.

5. The rewards program of claim 1 wherein said amount of rewards points purchased represents one percent of the purchase price of said consumer good.

6. The rewards program of claim 1 wherein said purchase of said rewards points is performed by a computer.

7. The rewards program of claim 6 wherein said purchase occurs when said purchase of said consumer good is completed.

8. A rewards program for consumer-to-consumer transactions of consumer leased goods, comprising:
a consumer-seller;
a consumer-buyer; and
a third party entity offering rewards points;
wherein said consumer-seller decides to lease a consumer good;
wherein said consumer-seller decides to purchase a certain amount of rewards points from said third party entity offering rewards points to incentivize the lease of said consumer good;
wherein said consumer-seller uses said rewards points to purchase additional goods or services to offer to said consumer-buyer; and
wherein said consumer-buyer is incentivized to enter said lease based on said additional goods or services purchased with said rewards points.

9. The rewards program for consumer-to-consumer transactions of claim 8, wherein said leased goods is real estate.

10. The rewards program of claim 8 wherein said amount of rewards points purchased represents one percent of the total value of the lease.

11. The rewards program of claim 8 wherein said purchase of said rewards points is performed by a computer.

12. The rewards program of claim 11 wherein said purchase occurs when said lease is executed.

13. A method for distinguishing real estate sales with rewards points comprising:
purchasing a certain amount of rewards points from a third party entity;
using said rewards points to buy incentives that will distinguish a home on the market;
offering said rewards points to buyers' real estate agents to incentivize showing said home on the market to potential consumer-buyers; and
selling said home on the market to a potential consumer-buyer due to the consumer-seller's use of said rewards points to distinguish their property.

14. A universal rewards card for increasing merchant loyalty, comprising
a first step of an entity associating its business with the universal rewards program to become a preferred vendor;
a second step of a consumer obtaining universal rewards points from purchases at said preferred vendor;
a third step of a consumer using said obtained universal rewards points for purchases at any vendor; and
wherein said universal rewards card is a loyalty device for the participating consumers.
